(19) United States
(12) Patent Application Publication
(10) Pub. No.: US 2016/0048612 A1
(43) Pub. Date: Feb. 18, 2016

(54) Method and Software Tool for Evaluation and Automated Generation of Space Habitat Interior Layouts

(71) Applicant: U.S.A. as represented by the Administrator of the National Aeronautics and Space Administration, Washington, DC (US)

(72) Inventor: Matthew A. Simon, Hampton, VA (US)

(73) Assignee: U.S.A. as represented by the Administrator of the National Aeronautics and Space Administration

(21) Appl. No.: 14/825,257

(22) Filed: Aug. 13, 2015

Related U.S. Application Data
(60) Provisional application No. 62/037,330, filed on Aug. 14, 2014.

(51) Int. Cl. G06F 17/50; B64G 1/60

(52) U.S. Cl. CPC G06F 17/5004; B64G 1/60

(57) ABSTRACT

Systems and methods of generating and evaluating a habitat interior design are provided. Generating a conceptual habitat layout includes defining one or more habitat requirements, generating a plurality of physical subsystems and geometric dimensions of the physical subsystems based on the one or more habitat requirements, and assigning a spatial position to each of the plurality of physical subsystems. Evaluating the conceptual habitat layout includes identifying and quantifying a plurality of habitat constraints, determining a plurality of quantifiable habitat layout evaluation criteria and a plurality of utility functions, calculating the plurality of utility functions for the conceptual habitat layout, and calculating a acceptability value of the conceptual habitat layout based on the plurality of utility functions. A layout having a highest acceptability value is determined from a plurality of generated conceptual habitat layout and a file configured to provide a blueprint of the layout is created.

### CROSS-REFERENCE TO RELATED PATENT APPLICATIONS

This patent application claims the benefit of priority to U.S. Provisional Patent Application No. 62/037,330, filed on Aug. 14, 2014, the contents of which are hereby incorporated by reference in their entirety.

### STATEMENT REGARDING FEDERALLY SPONSORED RESEARCH OR DEVELOPMENT

This invention was made by an employee of the United States Government and may be manufactured and used by or for the Government of the United States of America for governmental purposes without the payment of any royalties thereon or therefor.

### TECHNICAL FIELD

Aspects of this disclosure generally relate to systems and methods for generating habitat interior layouts, and in particular, relate to automatically generating and evaluating habitat interior layouts.

### BACKGROUND

Designing habitats, e.g., for crewed space missions, is a complex, highly constrained task with many conflicting objectives. One primary main objective of habitat design is to minimize mass and size while providing adequate space and a functional layout for crew health and productivity. For example, habitats must provide a living volume appropriate for the mission duration and capable of housing all of the functional systems and consumables required to support the crew (e.g., a breathable atmosphere, clean water, food, sleep quarters, workstations to support crew tasks, etc.). Maximizing habitability is an another important Objective, especially as exploration missions continue to increase in duration and include periods of moderate to low workload, while having few, if any, opportunities for abort. Failing to account for one or more of these factors may contribute to increased stress on the crew which can affect behavioral and/or physiological health, work productivity, as well as the incidence of errors throughout the mission. Therefore, the optimization of habitat designs is an important aspect of the development of human exploration missions.

The habitat design process involves the selection, sizing, and arrangement of the interior equipment and logistics required for a mission into an interior layout, which must fit within the habitat spacing. Arrangement of the interior equipment seeks to ensure that the interior equipment required for a crewed mission can be physically accommodated while providing the best compromise among various performance metrics such as mass, volume, workflow efficiency, and habitability. In addition to ensuring that all necessary functional systems are included and properly integrated, mass and cost should be minimized and habitability should be maximized. Particularly for space missions, minimizing mass is critical as habitats are often large, massive elements which must be pushed through most of a mission's propulsive maneuvers to support the crew. This, in turn, drives the design of launch vehicles and propulsion stages and often also drives the overall cost and complexity of a mission.

Balancing interior layout performance is especially critical at the conceptual design so that feasibility issues, safety concerns, and requirements violations can be identified before they result, in expensive design changes, increased mass, and/or reduced functionality. However, ensuring that an interior layout is effectively balanced is non-trivial as there are no known comprehensive and timely methods to measure the effectiveness of an interior layout and track the complex, conflicting habitat design objectives during conceptual design. The lack of layout information in known conceptual design processes is due to the slow, iterative, subjective, and mostly manual nature of such processes, For example, in some known processes, a habitat architect may interview with the customer to manually lay out a habitat concept which meets requirements and addresses some of the customer's needs. This process is iterated upon if time allows. Other approaches to automate the design of interior layouts may rely upon a long heritage of precedent designs and heuristics to specify placement of interior items, However, habitat interior designs continue to grow in complexity, becoming more constrained, more highly integrated, and subjected to more conflicting objectives, such that known processes have limited direct applicability in the conceptual design phases. This missing evaluation capability increases the uncertainty surrounding conceptual habitat designs and prevents further efforts to optimize habitat designs for improved exploration mission performance. Thus, known methods for evaluating the goodness of these layouts involve human-in-the-loop mockup tests, in-depth CAD evaluations, and subjective design evaluation studies. However, none of these methods are currently compatible with the conceptual phase of design or automation because of the significant time required to prepare and evaluate each layout.

Prior art solutions for designing habitat interior layouts have not resolved the need for ensuring adequate, and ideally, optimal effectiveness of a conceptual habitat layout. Therefore, there is a need for systems and methods that address one or more of these and other deficiencies.

### SUMMARY

The following presents a general summary of aspects of this invention in order to provide a basic understanding of at least some aspects of the invention. This summary is not an extensive overview of the invention. It is not intended to identify key or critical elements of the invention or to delineate the scope of the invention. The following summary merely presents some concepts of the invention in a general form as a prelude to the more detailed description provided below.

According to one aspect, a method may evaluate habitat interior layout design having human living and working spaces of a certain size against multiple objectives and constraints, and automatically generate feasible habitat interior layout design alternatives which meet defined requirements. The method may evaluate conceptual habitat designs by quantifying a multi-criteria objective function that will give one acceptability value of layout performance of the conceptual habitat design. The method may include a combination of numerical methods, geometry modeling, and systems engineering decision analysis methods. An objective function to obtain the acceptability value may be used with stochastic optimization techniques to automate the generation and evaluation of conceptual habitat designs.

Aspects of this disclosure relate to a method of generating and evaluating a habitat interior design. In certain embodiments, the method includes generating a plurality of conceptual habitat layouts and evaluating each of the conceptual habitat layouts. Generating the conceptual habitat layouts may include defining one or more habitat requirements, generating a plurality of physical subsystems and geometric dimensions of the physical subsystems based on the one or more habitat requirements, and assigning a spatial position to each of the plurality of physical subsystems for each conceptual habitat layout. Evaluating each of the conceptual habitat layouts may include identifying and quantifying a plurality of habitat constraints, determining a plurality of quantifiable habitat layout evaluation criteria and a plurality of utility functions, each utility function quantifying an evaluation criterion for a particular habitat layout, and calculating the plurality of utility functions for each conceptual habitat layout. An acceptability value of the conceptual habitat layout may be calculated based on the plurality of utility functions. A conceptual habitat layout having a highest acceptability value of the plurality of acceptability values may be determined. A file configured to provide a blueprint of the layout having the highest acceptability value may be created.

In certain embodiments, a method of evaluating a plurality of habitat interior designs may include repeating the above method of generating a conceptual habitat layout and evaluating the conceptual habitat layout for each of the plurality of conceptual habitat layouts, and determining a layout having a highest relative acceptability value.

In some embodiments, calculating the plurality of utility functions may include normalizing each of the plurality of evaluation criteria to common units, In some embodiments, calculating the plurality of utility functions may include applying criteria weighting to each of the plurality of evaluation. criteria, the criteria weightings corresponding to relative importance of each evaluation criteria. The method may further include determining a plurality of penalty functions for each of the habitat constraints and calculating the plurality of penalty functions for the conceptual habitat layout. Calculating the acceptability value may be further based on the penalty functions.

In certain embodiments, wherein the acceptability value is calculated using the equation: Y(A)=1−ΣᵢwᵢUᵢ(Xᵢ(A))+Σⱼ(Pⱼ(A)), wherein wᵢ is a relative importance weighting of each evaluation criteria i, Xᵢ(A) is a quantified habitat layout evaluation criteria corresponding to conceptual habitat layout A, Uᵢ(Xᵢ(A)) is a utility function value for each evaluation criteria calculated from Xᵢ(A), Pⱼ(A) is a penalty function value to enforce constraint j for layout A, being equal to 0 if constraint j is met and being equal to a multiplied by gᵢ(x), α is a constant indicating how hard constraint j is to be applied, and gᵢ(x) is a penalty function representing an amount constraint j is violated.

In certain embodiments, the plurality of quantifiable habitat layout evaluation criteria may include one or more of: total line run mass, habitable volume, unusable volume, spatial vista, anthropometric interferences between tasks, placement of items, separation for privacy, separation of clean spaces, and separation for noise. In certain embodiments, the one or more habitat constraints may include at least one of: a number of object-to-object collisions, a number of object-to-pressure vessel collisions; a number of anthropometric envelope-to-object collisions, a number of object-to-translation path collisions, and a number of object-to-hatch clearance envelope collisions.

Further aspects relate to methods of evaluating a conceptual habitat layout including determining a plurality of physical subsystems for the habitat based on predefined habitat requirements, determining a plurality of quantifiable habitat layout evaluation criteria based on the habitat requirements and a plurality of utility functions for quantifying each of the plurality of evaluation criteria, quantifying each of the plurality of evaluation criteria in relation to the positioning of physical subsystems in a conceptual habitat layout, calculating the plurality of utility functions for the quantified plurality of evaluation criteria, identifying and quantifying a plurality of habitat constraints, and calculating an acceptability value based on the plurality of utility functions and the plurality of habitat constraints, If the acceptability value is determined to meet an acceptability threshold, a file configured to provide a blueprint of the layout may be created,

In certain embodiments, quantifying the plurality of habitat constraints includes calculating a penalty function value for each habitat constraint, wherein the penalty function value is set to zero if an associated constraint is met. In some embodiments, quantifying each of the plurality of evaluation criteria may include grid-based numerical methods to assess volume-related evaluation criteria. Quantifying each of the plurality of evaluation criteria may include capturing distances between physical subsystems and other physical subsystems and capturing distances between physical subsystems and task locations associated with the physical. subsystems. Quantifying the plurality of habitat constraints may include collision detection based on a mathematical representation of a layout design, wherein the plurality of physical subsystems are represented by polyhedral objects and collision detection may include applying numerical grid-based iterative methods using Boolean collision detection tests.

Still further aspects relate to methods of evaluating a habitat interior including defining one or more habitat requirements, generating a plurality of physical subsystems and geometric dimensions of the physical subsystems based on the one or more habitat requirements, and generating a plurality of conceptual habitat layouts, each conceptual habitat layout assigning a spatial position of each of the plurality of physical subsystems. A plurality of habitat conceptual habitat layouts may be identified and quantified and a plurality of habitat constraints for each of the plurality of conceptual habitat layouts may be identified and quantified. For each of the plurality of conceptual habitat layouts, a plurality of quantifiable habitat layout evaluation criteria and a plurality of utility functions may be determined, each utility function quantifying the evaluation criteria. The plurality of utility functions for each of the conceptual habitat layouts may be calculated and the acceptability value may be calculated based on the plurality of utility functions for each of the plurality of conceptual habitat layouts. A maximum acceptability value of one of the plurality of conceptual habitat layout designs may be determined. A file configured to provide a blueprint of the layout having the maximum acceptability value may be created.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### DESCRIPTION OF THE FIGURES

FIG. 1 a flow diagram of a method for generating and evaluating habitat interior layouts in accordance with an embodiment.

FIG. 2A is a schematic view of physical subsystems associated with habitat requirements in accordance with an embodiment.

FIG. 2B is a schematic view of physical subsystems with spatial location in a conceptual habitat layout in accordance with an embodiment

FIG. 3 is a schematic view of a habitat layout in accordance with an embodiment.

FIG. 4 is a flow &again of a method for evaluating habitat interior layouts in accordance with an embodiment.

### DETAILED DESCRIPTION

In the following description of various examples of the habitat interior layout generation method, reference is made to the accompanying drawings which show, by way of illustration, various example systems and environments in which aspects of the present disclosure may be practiced. It is to be understood that other specific arrangements of parts, example systems, and environments may be utilized and structural and functional modifications may be made without departing from the scope of this disclosure.

In addition, the present disclosure is described in connection with one or more embodiments. The descriptions set forth below, however, are not intended to be limited only to the embodiments described. To the contrary, it will be appreciated that there are numerous equivalents and variations that may be selectively employed that are consistent with and encompassed by the disclosures below.

The present disclosure relates to methods and systems for automated generation of conceptual interior habitat layout designs and applying objective evaluation criteria to the layout designs. The methods and systems of the present disclosure may be applied in the design of highly constrained and highly integrated interiors, such as crewed space mission habitats. Application of objective evaluation criteria for evaluating a particular layout provides a comprehensive, measurable and automatable evaluation method which may capture a range of concerns related to engineering (e.g., mass and volume) as well as habitability (e.g., quality of volume, functionality, and safety).

Applications of aspects of the present disclosure may include comprehensive, quantifiable set of evaluation criteria, improved and efficient representations of layout geometry and subsystem characteristics, a structured method to capture designer preferences, and multi-criteria objective function providing an aggregate measure of overall layout effectiveness.

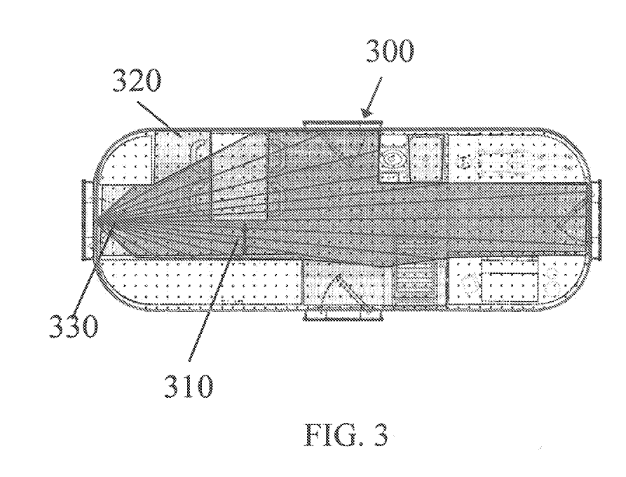

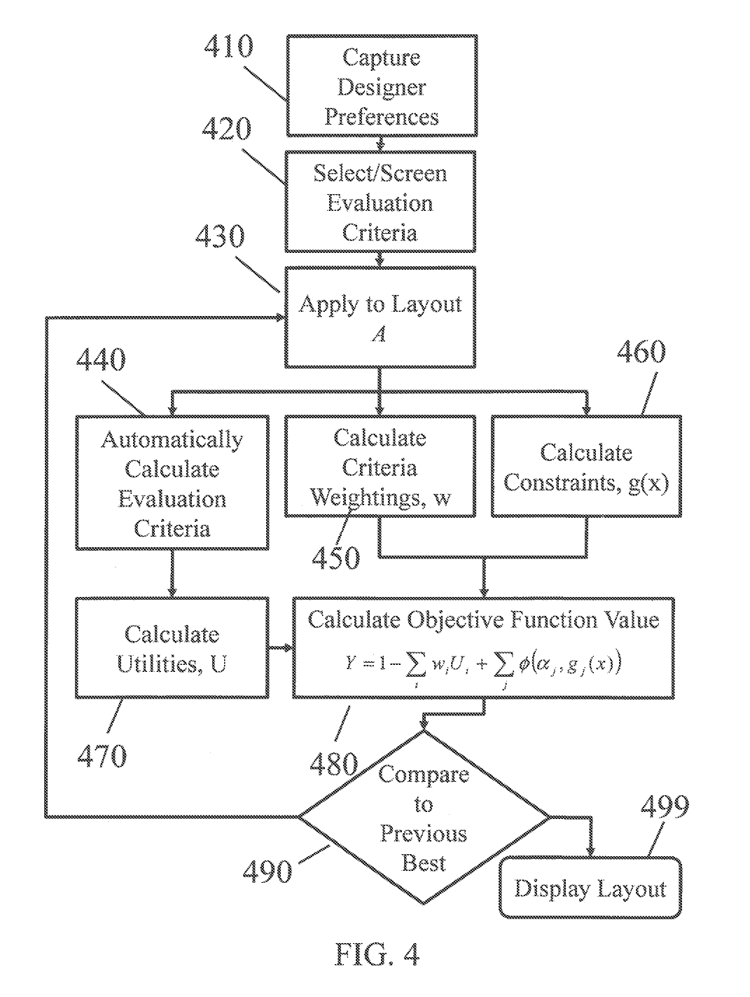

In order to evaluate multiple habitat interior layouts quickly and repeatedly, aspects of the present disclosure may quantify a multi-criteria objective function that may be applied to various habitat interior layouts. In some embodiments, a two-part process may be employed that includes (1) Layout Generation and (2) Layout Evaluation. Layout Generation may include translating mission requirements into conceptual layout geometric spatial blocks and then generating a plurality of mathematically representable habitat interior layouts using conceptual spatial blocks which are compatible with the evaluation process. Subsequently, the Layout Evaluation may include calculating an objective function value which measures an overall acceptability of each layout. FIG. 3 and FIG. 4 depict processes for the Layout Generation and the Layout Evaluation, respectively, in accordance with an embodiment.

Layout Generation Process

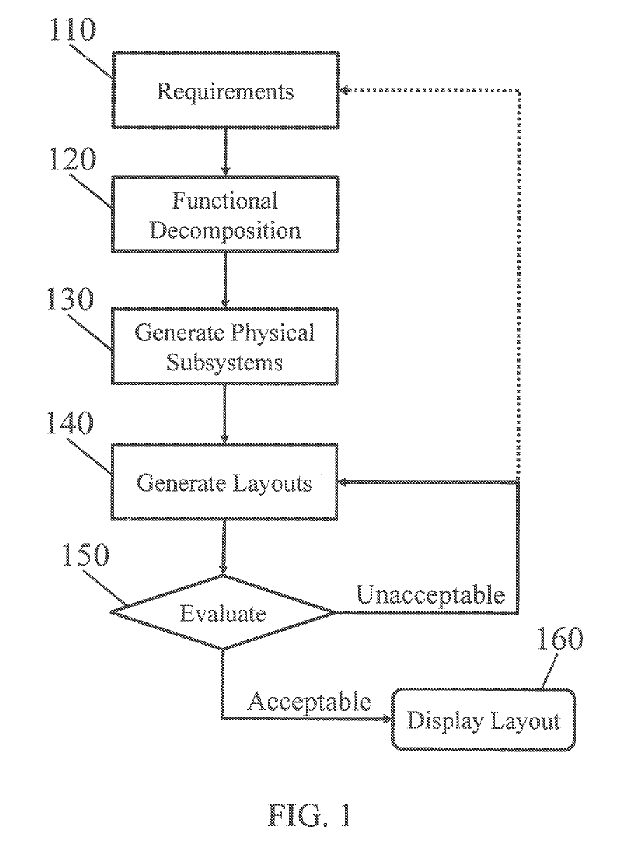

FIG. 1 depicts a flow diagram for generating a conceptual habitat interior layout in accordance with an embodiment. In generating a conceptual habitat interior layout, requirements may be translated into geometric representations of physical hardware that can then be constructed into layouts for evaluation. In certain embodiments, requirements of the design problem and any design constraints to be enforced are defined (e.g., block 110 of FIG. 1). For example, a design problem description with constraints may be to redesign existing interiors and/or generate new layout designs. For example, in one embodiment, the requirements and constraints may be directed towards redesigning an interior of an existing International Space Station module keeping the pressure vessel geometry constant, In another embodiment, the requirements and constraints may be directed towards designing a minimum mass lunar surface habitat. Additionally, specific mission requirements such as crewed duration, number of crew members, and the destination must be defined. Various other types of requirements and/or constraints may be defined at block 110 of FIG. 1, without departing from the scope of the present disclosure. These requirements may dictate the required functions and set appropriate context for the definition of designer preferences.

In further implementations, the required functions to achieve the mission may be identified, (e.g., block 120 of FIG. 1), such as through a functional decomposition of the various requirements defined at block 110, e.g., duration, mission tasks, destination requirements, and the like. Most habitats may provide many of the same fundamental functions, but a level of performance required within each function may vary at certain breakpoints as mission requirements change, e.g., become more challenging. Comparing the mission requirements to these breakpoints may lead to determining hardware necessary for the required performance. This hardware is then distributed amongst the habitat modules (if multiple modules are assumed), which may be based upon the specialized purpose of each habitat module, For example, a habitat concept with 180-day duration at a lunar surface destination may dictate the selection of appropriate subsystem hardware focused on group and work activities, which may include: a galley, wardroom, life support, stowage, waste and hygiene, medical, and a biology/life science research station.

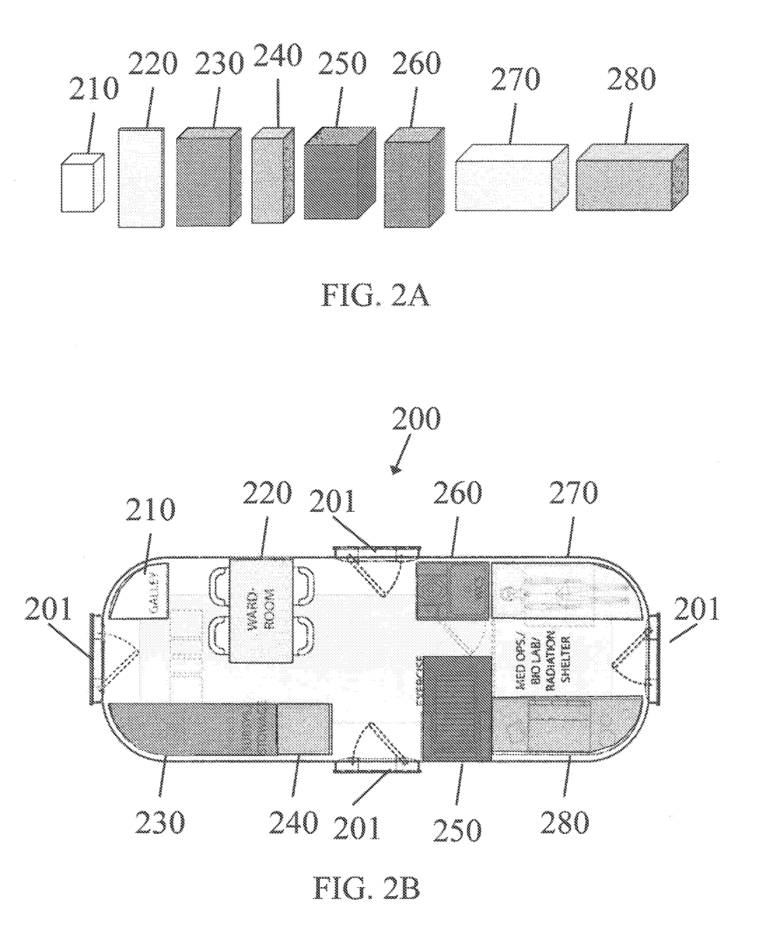

As illustrated by example block 130 of FIG. 1, physical subsystems may be generated. In one embodiment, their generation may involve the creation of a mathematical representation of hardware geometry and other characteristics of the equipment that influence its layout placement, e.g., tasks performed at hardware, mass, etc. CAD models and/or drafted drawings may be used to represent the space taken up by the hardware in the habitat interior layouts, however, such models often have long creation times and high complexity, both of which may be often incompatible with fast layout evaluation. Thus, according to some embodiments, simple polyhedral representations of the hardware geometry, e.g., derived from computer animation and video game programming, may alternatively be generated at block 130 for use in layout creation and evaluation criteria calculation methods. For example, by representing geometries as simple polyhedral objects specified by matrices of vertices and faces, the overlap of geometries can be detected with standard collision detection algorithms to prevent the creation of unrealizable layouts. Additionally, polyhedral object representation may allow for generation of layouts by simply manipulating the location and orientation of each subsystem through definition of translation and rotation matrices. Thus, such polyhedral object representation may allow for a fast, simple, mathematically operable method of constructing layout alternatives with relatively simple sets of data. An example of a set of physical subsystems represented as polyhedral objects in shown in FIG. 2A. Based on the defined requirements, eight example physical subsystems, 210-280 are generated.

At block 140 of FIG. 1, layouts may be generated, e.g., by assigning positions and orientations to each polyhedral object within the habitat interior space. As shown in FIG. 2B, physical subsystems, 210-280 are each respectively positioned within habitat interior 200 Additionally, object-oriented programming may be used to allow for the embedding of detailed function and interface information together with the geometry data in arrays or matrices within an indexed object. The types of object information required may include correlated inter-relationship factors, such as: the mass of an object, the function it belongs to, any separation or colocation relationships associated with the provided function, geometry and location of anthropometric envelopes reserved for human interaction with the object, keep out zones for moving parts, and the like. Colocated storage of this information with geometry data facilitates straightforward calculation of evaluation criteria which track characteristics of an object in combination with its geometry. At example block 150 of FIG. 1, the conceptual layout is evaluated using objective criteria as set forth herein as part of the layout evaluation process.

The evaluation process may be used to determine an acceptability value of a design, e.g., above or below a certain threshold or a maximum value of a plurality of conceptual habitat layout designs. If a particular layout is determined to be acceptable, according to the layout evaluation process as described herein, the layout may be displayed to the designer as an acceptable layout at block 160. For example, upon determining an acceptability value meets an acceptability threshold, a file configured to provide a blueprint of the layout may be created. If a particular layout is determined not to be acceptable, another layout may be generated, for example at block 140, and the process may continue. Alternatively, in certain scenarios, an unacceptable layout (or perhaps many unacceptable layouts) may indicate an improper setup and the process may return to an earlier point, such as block 110, to redefine one or more requirements.

Layout Evaluation Process

FIG. 4 depicts flow diagram for evaluating a conceptual habitat interior layout in accordance with an embodiment. Evaluating a conceptual habitat interior layout may combine quantitative evaluation criteria measurements, subjective designer preferences, and design problem constraints into a single aggregate measure of the overall performance of a layout. In order to enable the comparison of multiple layouts of conceptual designs for automated generation of acceptable layouts, this process and its component steps may preferably be structured to reduce the evaluation time of each layout. At block 410, before any layouts are evaluated, designer preferences are captured, which may include three types of information: (1) the relative importance of the evaluation criteria to establish criteria weightings, (2) desired values and acceptable ranges for each of the criteria to establish utility functions, and (3) any constraints the designer wishes to place on the design problem. By collecting this information before layout evaluation, the same preferences and constraints may be applied to multiple layout concepts.

Capturing designer preferences, such as at block 410, may include identifying criteria weightings which indicate the relative importance of each evaluation criterion and give the designer an opportunity to customize the objective function to his/her preferences and the appropriate context of the design problem. The criteria weightings may be determined through expert elicitation using analytic hierarchy process, a pair-wise comparison method which converts relative preferences scores between criteria to calculate normalized criteria weightings for each criterion. These weightings may be used at block 420 to select or screen evaluation criteria, e.g., to limit the number of evaluation criteria to those with the most effect on the objective function.

In order to ensure each of the evaluation criteria values are combined in the objective function using common units (thus preventing criteria with high numerical values from dominating the solution), a function is used to normalize each calculated criteria value. For example, the process may normalize values to a number between 0 and 1. For example, 0 may indicate the lowest permissible performance and 1 may indicate peak performance. Those skilled in the art will appreciate that other ranges or representations may be utilized without departing from the scope of this disclosure. A normalized score may represent a designer's perceived utility of a criteria value over the possible range of values. In many cases, linear utility functions may be acceptable. However, linear improvement in the value of an evaluation criterion may not always correspond to a linear improvement in the designer's preference of that value. For example, at low values of habitable volume (e.g., five cubic meters per person), slight volume increases may provide significantly improved human comfort, safety, or productivity. However, at high values (e.g., forty cubic meters per person), even large increases in volume have diminishing returns as the volume becomes spacious to the point of being wasted, This diminishing return may be reflected a habitable utility function which shows a negligible utility improvement past the value corresponding to the optimal amount of volume, e.g., having a logarithmic curve. Various methods for collecting and applying designer preferences for a range of evaluation criteria to shape a utility function that maps evaluation criteria values to utilities.

Hard constraints may also be defined, such as at example block 410 of FIG. 4. Hard constraints may establish limits to a layout design specified by designer preference, physical realizability car human/spaceflight standards which are placed upon either the physical location of interior equipment or the values of the evaluation criteria measurements. Examples of constraints may include hardcoded placement of certain pieces of hardware, prevention of overlapping hardware geometries, or human performance standard constraints like minimum volumes and minimum translation path widths. For hardware-hardware interferences, a configuration may be deemed unfeasible if any interferences occur. However, this setup may make automating the placement of interior components very difficult. For example, if a particular layout may be associated with close to optimal performance but a small clearance problem may cause it to be deemed unfeasible. Accordingly, selectively allowing interferences to some degree may improve traversal of the layout design space towards optimal configurations.

Penalty functions may be applied at the objective function level to implement constraints into the objective function, such as for example at block 460 of FIG. 4. Penalty functions may be setup to return exponentially increasing values as constraints are violated, which may then be subtracted from an unconstrained weighted sum of evaluation criteria. Such an objective function setup may prevent layout designs which violate constraints from being deemed acceptable. Interior penalty functions may increase before a constraint is violated in order to enforce hard constraints, which must be met for a layout to be deemed a feasible design. Exterior penalty functions may be used for soft constraints in which slight violations may be deemed acceptable. In general, exterior penalty functions may more allow flexibility in finding optimal layout designs. Additionally, constraints may be relaxed during early iterations of a layout design process to prevent a lack of freedom for the optimization method to explore the design space and some schedule of the rate of increase of the penalty functions may be implemented to avoid local optima.

Upon capturing designer preferences, evaluation criteria may be selected and/or screened (e.g., such as at example block 420 of FIG. 4), and applied to any particular layout, such as at block 430. The list of quantifiable evaluation criteria selected at block 420 may preferably capture both engineering and human habitability concerns. The development of a comprehensive set of quantifiable evaluation criteria calculable from layout geometry and hardware functional characteristics, such as at block 420, may be critical to ensuring high-quality habitat designs and speeding up the evaluation process.

In certain embodiments, to ensure a comprehensive set of criteria is chosen, a structured screening process may be used at block 420 of FIG. 4 to assess whether a criterion is essential to the assessment of interior layouts. Accordingly, a comprehensive list of all possible habitat interior layout evaluation criteria may first be created, e.g., based on extensive study space habitat design, space vehicle habitability, industrial engineering, and terrestrial architecture references (particularly from architectural programming, automation in architecture, and space layout planning field). Additionally, several of the more complete evaluation criteria sets used in existing and/or modified habitat designs may be included. A fully comprehensive list of all possible criteria may then be screened based upon a series of desired characteristics. Such desired characteristics may include: criteria which is as independent as possible from other criteria to prevent an over-emphasis on any particular measure; criteria explicitly dependent upon layout or pressure vessel geometry, which allows for the exclusion of many aesthetic criteria which may be changed with little to no impact after optimizing interior layouts; criteria that is intuitive and/or justifiable; criteria that is consistent with existing requirements, and the like. Additionally, it may be desired to include types of criteria recognized and approved by habitat design experts, the target users of methods according to the present disclosure.

An exemplary resulting comprehensive evaluation criteria set may be grouped into the following four categories: Mass, Volume, Task Performance, and Crew Health, Well-Being, and Safety.

Mass criteria may track the effect that the interior layout has on the overall mass of the habitat. Mass criteria may include at least one of: structure mass, equipment mass, and plumbing/electric line run masses. Structure mass may generally refer to mass of primary and secondary structures which vary depending on the configuration. Structure mass may include the pressure vessel, launch integration structure, hatches, windows, walls, floors, ceilings, and support mass for equipment. Equipment mass may generally refer to the mass of an Environmental Control and Life Support System (ECLSS), telecommunications systems, power distribution systems, stowage, crew accommodations, logistics, avionics, and other related equipment, though generally not including power and consumable distribution lines. Plumbing and electric line run masses may generally include a mass of power distribution, atmosphere distribution, vacuum, and various water distribution lines based upon the placement of interior objects, and the like, Line run mass may be quantified based on locations of systems or equipment and specifications of type of line run to each piece of equipment. Line run mass may be quantified by determining a minimum path, length connecting objects sharing a particular type of line run through mathematical calculation of distance (Manhattan, Euclidean, or the like) between objects for a full factorial set of possible path orders (ABCD, ABDC, BDCA, etc).

Volume criteria may measure the efficiency in the utilization of the interior volume and general psychological acceptability of the space. Volume criteria may include habitable volume, unusable volume, available non-dedicated stowage volume, habitable floor area and other usable horizontal surface area, and largest spatial vista.

Habitable volume generally may refer to the free, pressurized volume, excluding the space required for subsystems, structural elements, stowage, outfitting, accommodations, and structural inefficiencies. In other words, habitable volume may refer to an amount of space that is livable, accessible, and functionally usable to crew. Habitable volume may be quantified based on pressure vessel geometry, interior subsystem geometries and locations, and crew anthropometric dimensions. Habitable volume may further be quantified with numerical estimation methods using Boolean collision tests to identify usable volume. For example, habitable volume is indicated in FIG. 3 by block 320.

Unusable volume may generally refer to inaccessible volume and structural inefficiencies caused by a particular packing strategy, which is also not usable for stowage. Unusable volume may be quantified based on pressure vessel geometry, interior subsystems geometries and locations and crew anthropometric geometries. Unusable volume may further be quantified with numerical estimation using Boolean collision tests to identify wasted volume. Available non-dedicated stowage volume may generally refer to available space for the storage of goods within. the free volume outside of translation paths and anthropometric envelopes. Habitable floor area and other usable horizontal surface area may generally refer to floor area available for crew movement (e.g., anthropometrically accessible floor area by a standing crew member, excluding skinny spaces, space behind racks, under beds, under desks, and the like) and the area of horizontal surfaces occupied by crew including desks, tables, work counters, shelves, beds, and chairs.

Spatial vista analysis may be utilized in accordance with certain embodiments. In one implementation, largest spatial vista may be considered. As used herein, largest spatial vista may generally refer to the maximum volume swept by the viewable range of an observer, such as modelling by the eye of a crew member. Spatial vista analysis may be used as a measure of spaciousness and psychological/physiological acceptability of the environment. Largest spatial vista may be analogous to a maximum contiguous line of sight and contiguous field of view and may also be a measure of the quality of the interior volume. Largest spatial vista may be quantified based on pressure vessel geometry, interior subsystems geometries and locations, and crew anthropometric dimensions. Largest spatial vista may further he quantified with a numerical estimation using Boolean collision tests to identify line-of-sight lengths which can be integrated to calculate visible volume. For example, a series of line-of-sight lengths, (e.g., block 330 as depicted in FIG. 3), may be utilized as part of a quantification of largest spatial vista.

Task performance criteria may measure the impact of the layout to the productivity of crew through the impact of schedule-based factors and the placement of tasks within the habitat. Task performance criteria may include: colocation of sequential tasks, anthropometry of high duration task interferences, colocation of equipment by function, placement for function and ergonomics, and placement for high frequency and/or duration of use.

Colocation of sequential tasks may generally refer to a degree of colocation of tasks which are sequential according to analogous crew schedules. In other words, this may be a measure of overall minimized required crew translation distances throughout an interior. Anthropometry of high duration task interferences may generally refer to a number of long duration tasks whose anthropometric volumes interfere with at least one of: anthropometric volumes of other high duration tasks, translation paths, or hatch clearance areas. Anthropometry interference may be quantified based on pressure vessel geometry, interior subsystems geometries and locations, crew anthropometric geometries associated with each piece of hardware, and duration of tasks. Anthropometry interference may further be quantified by counting collisions detected between anthropometric volumes associated with each high-duration function and other high-duration functions, translation paths, and hatch clearance areas. Colocation of equipment by function may generally refer to a degree of grouping of equipment and components based upon the function or task they belong to.

Placement for function and ergonomics may generally refer to a measure of the displacement of equipment from the location required by its function or ergonomic operation. For example, a desk in a gravity environment should be approximately 36 inches from the floor. Placement for high frequency and/or duration of use may generally refer to a measure of the displacement of high frequency/duration of use equipment from prime locations for human interaction (e.g., along wall, away from hatches, waist to eye level). Placement for high frequency and/or duration of use may be quantified based on ranges of acceptable positions fur use of objects, nominal values for position of frequency uses of an object, actual locations of various objects, frequency of use and duration of use for each object. Placement for high frequency and/or duration of use may further be quantified by calculating a weighted sum of utility functions which are defined by optimal locations for ergonomic evaluation criteria and weightings normalized by frequency and duration of use, which is then summed for all objects.

Crew health, well-being, and safety criteria may track various factors which directly impact the physiological or psychological health of the crew or pertain to contingency operations. Crew health, well-being, and safety criteria may include size of private spaces, separation for privacy, separation of clean and dirty zones, separation for noise, and minimum translation path width.

Size of private spaces may generally refer to the size of the crew quarters, waste and hygiene closets, or other space designated as private. Separation for privacy may generally refer to a degree of separation between public and private areas, such as the crew quarters and wardrooms. A measure of the separation of public functions from private functions may be ranked by a degree of separation and ranked based on a degree of being a group function or an individual function. Separation for privacy may be quantified based on interior subsystem location, associated subsystem functions, and separation relationships. Separation for privacy may further be quantified with functional relationships using the Euclidean-norm of the Hadamard product of separation relationships and Euclidean distance matrices.

Separation of clean and dirty zones may generally refer to a degree of separation between clean and dirty areas, such as crew quarters and hygiene areas. Separation of clean and dirty zones may be quantified based on interior subsystems locations, associated subsystem functions and separation relationship, and using functional relationships analysis using the Euclidean-norm of the Hadamard product of separation relationships and Euclidean distance matrices. Separation for noise may generally refer to a degree of separation between noisy and quiet areas, such as crew quarters and the wardroom area. Separation for noise may be quantified based on interior subsystem locations, associated subsystem functions, and separation relationships, and using functional relationships analysis using the Euclidean-norm of the Hadamard product of separation relationships and Euclidean distance matrices. Minimum translation path width may generally refer to the minimum width along a path which allows access to hatches and subsystems. For example, a translation path width 310 is shown in FIG. 3 between a wardroom. subsystem and a subsystem stowage area.

In accordance with certain implementations, user measurement of evaluation criteria may be reduced to quantitative measures in order to ensure consistent evaluations and/or to accelerate the evaluation process. Accordingly, qualitative criteria may be reformulated to quantitative criteria according to aspects of the present disclosure. For example, spaciousness may be considered a broad measure of psychological acceptability of the size and shape of an interior layout that is measured by a wide range of quantitative and qualitative criteria. Quantitative measures may be easily measurable and straightforward in definition, while qualitative measures may be more difficult to measure, as they deal more with perception than physical measurement. Qualitative measures can be divided into three basic categories: semi-layout independent, perception driven, and designer preferences. Semi-layout independent measures may include color or a clean look and tend to be modifiable with little to no impact on the design, layout, or size and can be removed from consideration. Designer preferences may include the relative importance of each of these measures or the acceptable values of each criterion as discussed herein with regard to weightings and utility functions.

Perception-driven measures may still be dependent upon layout, but may only be determined with user assessment of the layout in an analogous test situation. However, measurable proxy variables can be used to approximate qualitative perception based criteria. For example, crowdedness may measure the degree to which crewmembers will feel crowded or that their tasks are impeded by the presence of other crew members. This factor is strongly correlated with privacy criteria which measure the extent to which crew feel that their privacy needs are met. The combination of several quantitative measures like the number of overlaps of high-frequency and high duration tasks (using schedules and task locations to measure how often crew locations might overlap) and the width of the translation paths (measuring the ability of crew to pass by one another without intersecting) can approximate the potential for crowding. Similarly the size and distribution of private and public spaces may also approximate aspects of crowdedness and privacy. By mapping qualitative perception-based measures to quantitative proxies which approximately measure the same factors, a fully quantitative criteria set can be created. Accordingly, the various criteria discussed herein may be measured directly or by some quantitative proxy, thus ensuring that these criteria can be automatically measured.

Objective Function

After the evaluation criteria is selected and/or screened (e.g., such as at block 420 of FIG. 4) and applied to a layout A, the objective function is applied to evaluation layout A, by assembling and/or calculating a weighted, constrained multi-criteria objective function from designer preferences, evaluation criteria values, and applicable constraints, The objective function may include calculating constraints (e.g., such as at block 460), calculating criteria weightings (e.g., such as at block 450), automatically calculating each of the evaluation criteria (e.g., such as at 440) and calculating utilities (e.g. such as at block 470). The calculated utilities, criteria weighting and constraints may then be applied to calculate an objective function value, i.e. an acceptability value, which for example, may be performed as part of block 480.

For example, a weighted-sum multi-criteria objective function applied at block 480 may be represented by the equation: Y(A)=1−ΣᵢwᵢUᵢ(Xᵢ(A))+Σⱼ(Pⱼ(A)), wherein u>ᵢ is a relative importance weighting of each evaluation criteria i, Xᵢ(A) is a quantified habitat layout evaluation criteria i corresponding to conceptual habitat layout A, Uᵢ(Xᵢ(A)) is a utility function value for each evaluation criteria calculated from Xᵢ(A), Pⱼ(A) is a penalty function value to enforce constraint j for layout A, being equal to 0 if constraint j is met and being equal to a multiplied by gᵢ(x), α is a constant indicating how hard constraint j is to be applied, and gᵢ(x) is a penalty function representing an amount constraint j is violated.

The resulting function applied at block 480 may represent an aggregate measure of the overall performance of a layout for the specific set of designer preferences and provide a structured and quantifiable way to justify the selection of one configuration over another and provide insight into which interior design features most directly affect the goodness of a configuration. Furthermore, eliminating or reducing subjectivity in the measures of layout effectiveness enables the use of a stochastic optimization method to quickly improve interior layout designs, so long as the methods used to calculate the evaluation criteria are not too time consuming. Further, the quality of each evaluation may greatly depend on the fidelity of the modeling and supporting data that feeds into the measured evaluation criteria values. Low-medium fidelity data may be used to demonstrate the operation of the methodology as described herein.

Evaluation Criteria Quantification Methods

Though each of the evaluation criteria as discussed herein may be quantifiable, user interaction may still be involved to calculate various values. For example, habitable volume may be a quantifiably measurable quantity, but a method for measuring it from an interior layout may include manual measurement using a CAD model. Several other desired characteristics of the measurement methods may include, but are not limited to: calculable from layout and available data, with no user interaction; require minimal computational time to solution; scalable to various design precisions; traceable to definitions of measures provided in references; and easy to setup. Several mechanisms may enable the automatic calculation of evaluation criteria values including, but not limited to: collision detection; grid-based numerical methods; and separation/colocation matrices.

Collision detection (also known as interference detection or contact determination) includes the detection of contact, overlap, or intersection of geometries. In the evaluation of habitat layout alternatives, collision detection may serve two purposes. First, interferences between pieces of hardware and between hardware and pressure vessel structure may be detected to ensure that only physically realizable layouts are acceptable. Second, collision detection may be used to measure several of the volume evaluation criteria which measure volume or task performance criteria counting potential interferences between different types of objects. Collision detection may include testing if a point is in an interior of an object, determining an intersection point between a line and an object, and collision detection between three-dimensional geometries. Testing if a point is inside an object may allow for the determination of sizes of open volumes when combined with numerical methods. Determining the intersection point between a line and an object may be used to determine line of sight distances. Collision detection between three-dimensional geometries may enable the detection of interferences between pieces of hardware or anthropometric envelopes and may be critical to the calculation of a realizability constraint. In evaluating various collision detection methods, several important factors include: performance (i.e., run time), accuracy in detecting collisions, and ease of implementation. For example, based upon these factors, the Incremental Separating Axis-Gilbert-Johnson-Keerthi algorithm may be selected for each of the three types of collision detection discussed herein. This algorithm (as described in Gilbert, E. G., Johnson, D. W., Keerthi, S. S., “A Fast Procedure for Computing the Distance between Complex Objects in Three-Dimensional Space”, IEEE Journal of Robotics and Automation, vol. 4, no. 2, 1988; and van den Bergen, Gino, Collision Detection in Interactive 3D Environments (The Morgan Kaufmann Series in Interactive 3D Technology) Morgan Kaufmann, October 2003, the disclosures of which are incorporated herein by reference in their entirety for any and all non-limiting purposes) may provide fast and consistent collision detection between any two convex geometries, by modeling a test point as a small sphere enabling one type of collision test for all applications.

Because numerical methods requiring several million collision detection calls may be used to calculate evaluation criteria, fast and reliable collision detection is important for the objective function. The primary way of ensuring real-time performance of collision detection methods may include eliminating low-level tests by removing pairs of objects which clearly do not collide from consideration, which may be accomplished by bounding volumes and spatial partitioning. Bounding volumes use simplified geometries to approximate more complicated objects and spatial partitioning sets up a hierarchy to reduce the number of object pairs tested based upon their location, only testing those in the same region of space. For example, axis aligned hierarchal partitioning where each parent can have eight children known as an octree may be used in this analysis.

Automatic methods of measuring and characterizing different types of volume may prevent the need to include CAD-based manual measurement of volumes. For example, a numerical integration approach using an orthogonal Cartesian grid of discrete test points spanning the pressurized volume of the habitat may be used. This method may first tests points in space to determine if they are occupied by hardware and then applies several Boolean collision detection tests based upon the definitions of volume-based criteria to determine if the point should count towards a particular type of volume. After characterizing all points in the pressurized volume, the total amount of a particular type of volume may then be determined by summing the points conforming to the criteria definition and using this sum with the resolution of the grid to make a numerical approximation to the volume represented by the points. For example, a test point may be characterized as part of the habitable volume by testing whether it is within the free, accessible, and functionally usable volume. The specific Boolean tests used to determine if the point should be included in habitable volume may include point-hardware collision. tests which may determine: if a point is inside of the pressure vessel; if a point is under the floor or above the ceiling (as represented by polyhedral geometry features); is a point is inside any hardware geometry; if a point is above reachable height (assuming a non-microgravity environment); if a point is accessible by a standing or prone crewmember; and if a point is accessible by a reaching arm connected to a standing or prone crewmember. These points may then be summed to calculate the total habitable volume. A similar set of test points may be defined for all of the volume-related evaluation criteria.

A discrete grid of points may also be used for iterative methods of defining length-based evaluation criteria, particularly spatial vista and minimum aisle width. Spatial vista measures the maximum amount of volume that a crewmember can see within the habitat. The point of origin. from which the viewer's perspective originates is important to the find a maximum possible volume. The discrete points in the grid may be used in combination with an optimization method to converge to the point of view measuring the maximum spatial vista. Similarly, to quantify the minimum translation path width, points of origin may be on the translation path, which changes with every layout. The grid of points may be used with a robot path planning algorithm to construct a translation path from the available points. Then these identified points may be used as the points of origin for the measurement of translation path width.

For even moderately sized habitats, the assumed resolution of the grid necessary to get accurate measurements may include a computationally prohibitive amount of points. For example, a habitat with 3-meter diameter and 7-meter length may take as many as 60 million points to characterize the space. Storing data such as the location and exact characteristics of each of these points may be difficult and/or time-consuming. Two methods may be taken to prevent this problem: reduced grid resolution and additive calculation with no data. Reduced grid resolution may be used to reduce the number of points which must be tracked. This is particularly important in finding the minimum translation path width which tracks location of points in the translation path. Additive calculation with no data may be used to eliminate the need for data storage. For example, when calculating habitable volume, the number of points passing each of the Boolean tests may be counted using a running counter to determine the volume.

Several evaluation criteria may measure how well the functional relationships between systems are accommodated by their location, or the degree to which conflicting or complementary hardware are separated or colocated, respectively. A calculation method may utilize two types of matrices: matrices capturing the functional relationships between crew tasks and matrices of the distances between objects. Matrices capturing the functional relationships between crew tasks may be drawn from station crew schedules and crew preference elicitation. Mapping these tasks to pieces of hardware may provide guidance as to whether hardware should be separated or colocated based upon specific criteria such as noise, hygiene, etc. Matrices of the distances between objects may be defined based upon the layout and combined with the function relationships matrices to derive a measure of how successful the layout is at accommodating these functions. The distances included in these matrices need not be restricted to Euclidean distances. Some criteria include visual separation or hygiene separation which can be augmented by partitions while others dealing with the length of shared consumable lines which run along the pressure vessel of the habitat behind equipment may hest be measured with some cylindrical mapping of Manhattan distance.

In order to derive a single measure of the overall effectiveness of a layout to capture these relationships, the Euclidean norm of the Hadamard Product of the Relationships and Distance matrices may be used. While this quantity may not be physically interpretable as any measurement, it can be compared to the range of possible values of this product determined by a design space exploration of the distance matrix for the specified pressure vessel geometry to gage its performance against possible values. Detailed automatically calculable algorithms may be created for each of the evaluation criteria by implementing combinations of each of the three enabling mechanisms with logical definition-derived measurements. These algorithms may be designed for implementation in an object oriented programming language compatible with basic geometry modeling.

Example Tool Implementation

Various software languages, including C++ and OpenGL, may be used to implement the method according to the present disclosure across one or more hardware systems. A particular language may be selected primarily because of the availability of collision detection libraries and the ability to generate a transferrable executable file to facilitate sharing. In accordance with one embodiment, a non-transitory computer-readable medium may comprise computer-executable instructions that when executed by a processor, cause the processor to at least: (1) define the problem description information, such as the size of the habitat. The definitions may be calculated from different methods and/or received from one or more divergent sources; (2) receive information about pieces of hardware to be included in the layout, which may be electronically read from input files (including the geometry of these objects, geometry of reserved volume to interact with them, mass, volume, what tasks are associated with hardware, etc.); and (3) identify, with a processor, the positions of hardware in this input file to model one layout or they may be separately defined in another file to create a population of layouts. All of the information about the objects may be stored in structures, which may allow for colocation and facilitated access of geometry, position, and functional relationship data. Other input files may capture the utility functions and criteria weightings which are determined from expert elicitation over the course of a few hours, but these inputs may also be pulled from libraries of previous runs in future code implementations.

After all input information is captured, the evaluation criteria may be calculated from the hardware, layout, and relationship data. Iterative methods with several Boolean tests may be used to measure volumes, numbers of interferences, and priority placement of hardware. For other criteria, simple analytical calculations may be used to obtain values. Values for these criteria are combined with input utility function parameters to map these measured values to the utility values, which are then combined with weightings in a weighted, sum to obtain the unconstrained performance of each layout. Next, a set of collision tests may be used to calculate constraint violations. Violated constraints may then be added to the unconstrained objective function values to obtain the constrained performance of a layout. Images of the layout may then be rendered, e.g., using the OpenGL visualization capability with transparent blue and yellow boxes to track the reserved volumes and translation paths.

In addition to evaluating single layouts, the tool may be set up to generate new layout matrices and evaluate multiple alternative layouts. These populations of layouts may be generated using Particle Swum Optimization (PSO), stochastic optimization algorithm used for similar problems in space layout planning. This algorithm may alter the layout matrices based upon global and personal best objective function values in previous iterations. Alternative methods derived from PSO may also be used to achieve better optimization performance.

At block 490 of FIG. 4, the calculated objective function value is compared to a previous best value, e.g., from previously generated conceptual designs. The method of evaluated layouts may be repeated for a plurality of layout to determine a best objective function value (which in certain embodiments may be fulfilled at least in part by repeating blocks 430 through 490 disclosed herein). Upon evaluating each conceptual design for a plurality of conceptual designs and determining a conceptual design having a best (e.g., highest) objective function value, the determined best conceptual design may be outputted (e.g., such as displayed at 499), For example, a file configured to provide a blueprint of the layout having a best acceptability value may be created.

Example Problem: 180 day Cis-Lunar Habitat

In order to demonstrate methods of the present disclosure, the following example design problem is proposed: Evaluate the layout performance of a cis-lunar habitat designed to sustain four crewmembers for 180 days in deep space with an entry capsule. Assume the spacecraft is 4.5 meters in diameter and 6 meters long with one hatch on an endcap. Assume a pre-defined set of rack-based hardware with standard anthropometric use envelopes, which is to be packaged within this habitat while maintaining a central translation path corridor.

The topology of the baseline layout to be evaluated may be shown with the positions of each of the subsystems indicated by the rows which correspond to the standard wall, ceiling, and floor rack locations. For example, subsystems included may be: maintenance, oxygen generation, galley, power, water storage, air revitalization, wardroom, mixed ops, and four crew quarters modules. The functions in this module (long duration accommodations and closed loop life support) are focused on increasing crewed duration while functions in attached modules are focused on increased exploration and science.

In certain implementations, the evaluation may set forth definition of preferences, such as designer preferences. First, the evaluation criteria are weighted based upon the design problem context. Evaluation criteria included may be: plumbing/electric line run masses, habitable volume, unusable volume, largest spatial vista, anthropometry of high duration task interferences, placement for high frequency and/or high duration use, separation for privacy, separation of clean and dirty zones, and separation for noise. For example, pair-wise comparisons of the evaluation criteria may be performed to create a prioritized list where the weightings are expressed in percentages. The criteria used to evaluate the cis-lunar habitat may then be reduced to those which make up the top 80% of the weightings. Linear utility functions may be assumed for these criteria with preset value ranges. Habitable volume ranges may be set based upon human spaceflight design documents, but may be modified if additional living volumes are assumed to be provided by additional modules. Other criteria value ranges may be assumptions based upon values seen in a quick analysis of possible layouts.

For simplicity, the only constraints chosen for this example problem are hardware interferences (“object-object” and “object-wall”) and clearance checks (“anthropometric envelope-object”, “object-translation path”, and “abject-hatch clearance envelope”). Constraints may be implemented based upon the number of interferences observed. For example, some multiple of the number of anthropometric reserved volume and object collisions may be added to the unconstrained objective function to decrease acceptability. These tests may be implemented with the same ISA-GJK collision detection test used for the evaluation criteria quantification methods.

Evaluation of the baseline layout yields a first set of results. Assuming the utility ranges are appropriate, the resultant utilities may indicate which if any of the evaluation criteria perform well. For example, all evaluation criteria may perform moderately well except line run mass, spatial vista, and separation of clean and dirty tasks. Because of the somewhat arbitrary selection of value ranges in the utility function definitions, few definitive conclusions can be drawn about whether the performance of the layout for a specific criterion is acceptable or not. However, comparing multiple layouts with the same set of assumptions and designer preferences allows for the determination of a relative acceptability of the layouts which can be used to guide iterations towards an optimal solution.

For example, trading the rack based locations of a few subsystems may yield a new set of results, which may, for example, perform better on line run mass and anthropometric interferences, but at the expense of the separation-colocation criteria and placement for high duration and/or frequency of use. Because of the relatively high weighting of these separation-colocation criteria, this significantly decreases the overall acceptability of this layout.

The evaluation method according to the present disclosure may successfully deliver structured, fast, and complete habitat interior evaluations useful for habitation design community and any other community designing highly constrained, highly integrated interiors, The methods of the present disclosure include the development of a comprehensive, measurable set of evaluation criteria which capture a full range of engineering (mass and volume) and habitability (quality of volume, functionality, safety, etc.) concerns and the development of automatic methods to measure them. These quantification methods substantially increase the state of the art in evaluation times (each layout evaluation requiring numerical volume estimations may be performed in about a second, while evaluations not requiring numerical methods may be several orders of magnitude faster). These that criteria measurement methods may substantially increase the information available at the conceptual design phase and provide a structured and quantifiable way to justify the selection of one configuration over another for a given set of objective preferences, which will enable trades to be performed identifying the architectural elements which most directly affect the ‘goodness’ of a configuration. The methods may also increase available knowledge of the mechanisms of designing utility into interior designs and enable designers to trade the shapes/sizes of hardware and pressure vessels to suit the objectives dictated by the mission.

The methods may also enable the automated generation of layout interior designs by implementation of a particle swarm optimizer to deal with the discontinuous, multi-modal nature of the interior layout design space. The addition of fast interior layout generation and optimization to the evaluation tool may also allow designers to respond to requirements changes, investigate what-if scenarios, and ensure good integration with other elements of the system architecture as the concept is developed (e.g., lander, propulsive stages, and launch vehicles). The methods may also enable early representation of the layout dependent habitat design concerns affecting mission design or the design to project management or other element design teams during conceptual design; provide more complete coverage and documentation of the configuration design space, leading to the discovery of better alternatives or the identification of important features which improve the design; enable designers to provide justified push-backs on limiting constraints or requirements for the first time in literature; reduce design time and resources to save in development costs both directly and indirectly, by requiring less expensive design changes later in the product lifecycle; and enable trade studies, including understanding the impact to the habitat configuration when trading various requirements, managerial preferences (weightings), choice of subsystems, and different component geometry shapes. Trades such as these can be used to expedite knowledge normally discovered in later design stages to the conceptual design phase.

Various methods and systems of the present disclosure further enables automation of habitat interior layout designs, by conceptually sizing and designs habitat layouts with consideration of a layout's effect on habitability, usability, and crew health designs, among other factors. Further, the present disclosure provides an optimization method fur evaluating habitat interior layout which uses position targeting routines with collision detection for stochastic optimization methods with feasible designs close to the desired target design for each iteration. When combined with equipment selection and mass sizing/cost analyses, various methods of the present disclosure may enable overall conceptual design optimization.

Further, aspects of the present disclosure relate to developing a comprehensive set of habitat layout evaluation criteria and enabling fast generation and evaluation if the habitat interior layout designs. A comprehensive set of evaluation criteria may provide a structured and quantifiable way to justify selection of one configuration over any others for a given set of objective preference of the habitat designs, which will enable trades to be performed in generating a conceptual layout design which identify architectural elements which most directly affect the optimization of a particular configuration. The present disclosure may further increase available knowledge of the mechanisms of designing utility into habitat interior layout designs and enable designers to trade the shapes of hardware and pressure vessels to suit the objectives dictated by the mission and facilitate designer capabilities to respond to requirements changes, investigate alternative scenarios and ensure good integration with other elements of the system architecture as the concept is developed. Further, enabling early conceptual representation of the habitat interior layout design may address concerns affecting mission design or the design to project management or other element design teams during conceptual design and provide more complete coverage and documentation of the configuration design space, leading to the discovery of better alternatives or the identification of important features which improve the design.

The present disclosure may also enable justification of limiting constraint or requirements and reduce design time and resources both directly and indirectly (e.g., more optimized configuration may require less expensive design Changes later in the product life cycle). Aspects of the present disclosure may also enable trade studies, including understanding the impact to the habitat configuration when trading various requirements, managerial preferences (weightings), choice of subsystems, and different component geometry shapes. Trades such as these can be used to expedite knowledge normally discovered in later design stages to the conceptual design phase.

This methods and systems of the present disclosure, although specifically implemented for conceptual space habitat design applications, may also be applicable for any highly constrained human system (e.g., recreational vehicles, submarines, naval vessels, aircraft, small terrestrial residences, some factories, workstation design, etc.) for which a set of design objectives can be defined. For spacecraft design, this innovation will allow for early determination (in the conceptual design phase) of the adequacy of habitat size from a layout perspective and the potential identification of design issues related to interior layouts. This will result in higher fidelity conceptual designs leading to mass and cost savings for future exploration missions.

While preferred embodiments and example configurations of the invention have been herein illustrated, shown and described, it is to be appreciated that various changes, rearrangements and modifications may be made therein, without departing from the scope of the invention as defined by the claims. It is intended that specific embodiments and configurations disclosed are illustrative of the preferred and best modes for practicing the invention, and should not be interpreted as limitations on the scope of the invention as defined by the appended claims and it is to be appreciated that various changes, rearrangements and modifications may be made therein, without departing from the scope of the invention.

While the invention has been described with respect to specific examples including presently preferred modes of carrying out the invention, those skilled in the art will appreciate that there are numerous variations, combinations, and permutations of the above described systems and methods. Those skilled in the art will understand that various specific features may be omitted and/or modified in without departing from the invention. Thus, the reader should understand that the spirit and scope of the invention should be construed broadly as set forth in the appended claims.

We claim:

1. A method of generating a habitat layout comprising:
generating a plurality of conceptual habitat layouts including:
electronically defining one or more habitat requirements;
generating, with a processor, a plurality of physical subsystems and geometric dimensions of the physical subsystems based on the one or more habitat requirements;
assigning a spatial position to each of the plurality of physical subsystems for each of the plurality of conceptual habitat layouts; and
evaluating the conceptual habitat layouts including, for each conceptual habitat layout:
identifying and quantifying a plurality of habitat constraints;
determining a plurality of quantifiable habitat layout evaluation criteria and a plurality of utility functions, each utility function quantifying an evaluation criterion for a particular habitat layout;
calculating the plurality of utility functions corresponding to each of the conceptual habitat layouts; and
calculating an acceptability value of each of the conceptual habitat layouts based on the corresponding plurality of utility functions;
determining a conceptual habitat layout having a highest acceptability value of the plurality of acceptability values; and
creating a file configured to provide a user-viewable blueprint of the layout having the highest acceptability value.

2. The method of claim 1, wherein the physical subsystems include at least one of: a galley, a wardroom, a life support subsystem, a stowage subsystem, a waste and hygiene subsystem, a medical subsystem, and a biology/life science research station

3. The method of claim 1, wherein calculating the plurality of utility functions includes normalizing each of the plurality of evaluation criteria to common units.

4. The method of claim 1, wherein calculating the plurality of utility functions includes applying criteria weighting to each of the plurality of evaluation criteria, the criteria weighting corresponding to relative importance of each evaluation criteria.

5. The method of claim 1, further comprising determining a plurality of penalty functions for quantifying each of the habitat constraints and calculating the plurality of penalty functions for the conceptual habitat layout, and wherein calculating the acceptability value is further based on the penalty functions.

6. The method of claim 1, wherein the acceptability value is calculated using the equation:
Y(A)=1−ΣᵢwᵢUᵢ(Xᵢ(A))+Σⱼ(Pⱼ(A)),
wherein:
wᵢ is a relative importance weighting of each evaluation criteria i,
Xᵢ(A) is a quantified habitat layout evaluation criteria i corresponding to conceptual habitat layout A,
Uᵢ(Xᵢ(A)) is a utility function value for each evaluation criteria calculated from Xᵢ(A),
Pⱼ(A) is a penalty function value to enforce constraint j for layout A, being equal to 0 if constraint j is met and being equal to a multiplied by gⱼ(x),
α is a constant indicating how hard constraint j is to be applied, and
gⱼ(x) is a penalty function representing an amount constraint j is violated.

7. The method of claim 1, wherein the plurality of quantifiable habitat layout evaluation criteria includes one or more of total line run mass, habitable volume, unusable volume, spatial vista, anthropometric interferences between tasks, placement of items, separation for privacy, separation of clean spaces, and separation for noise.

8. The method of claim 1, wherein the one or more habitat constraints include at least one of: a number of object-to-object collisions, a number of object-to-pressure vessel collisions; a number of anthropometric envelope-to-object collisions, a number of object-to-translation path collisions, and a number of object-to-hatch clearance envelope collisions.

9. A method of evaluating a conceptual habitat layout comprising:
determining a plurality of physical subsystems for a habitat interior based on predefined habitat requirements;
determining a plurality of quantifiable habitat layout evaluation criteria based on the habitat requirements and determining a plurality of utility functions for quantifying each of the plurality of evaluation criteria;
quantifying each of the plurality of evaluation criteria in relation to the positioning of physical subsystems in the conceptual habitat layout;
calculating the plurality of utility functions for the quantified plurality of evaluation criteria;
identifying and quantifying a plurality of habitat constraints;
calculating an acceptability value based on the plurality of utility functions and the plurality of habitat constraints
determining if the acceptability value meets an acceptability threshold; and
upon determining the acceptability value meets an acceptability threshold, creating a file configured to provide a user-viewable blueprint of the layout.

10. The method of claim 9, wherein quantifying the plurality of habitat constraints includes calculating a penalty function value for each habitat constraint, wherein the penalty function value is set to zero if an associated constraint is met.

11. The method of claim 9, wherein quantifying each of the plurality of evaluation criteria includes grid-based numerical methods to assess volume related evaluation criteria.

12. The method of claim 9, wherein quantifying each of the plurality of evaluation criteria includes capturing distances between physical subsystems and other physical subsystems and capturing distances between physical subsystems and task locations associated with the physical subsystems.

13. The method of claim 9 wherein quantifying the plurality of habitat constraints includes collision detection based on a mathematical representation of a layout design, and wherein the plurality of physical subsystems are represented by polyhedral objects.

14. The method of claim 13, wherein collision detection includes applying numerical grid-based iterative methods using Boolean collision detection tests.

15. A method of evaluating a habitat interior comprising:
defining one or more habitat requirements;
generating a plurality of physical subsystems and geometric dimensions of the physical. subsystems based on the one or more habitat requirements;
generating a plurality of conceptual habitat layouts, each conceptual habitat layout assigning a spatial position of each of the plurality of physical subsystems;
identifying and quantifying a plurality of habitat constraints for each of the plurality of conceptual habitat layouts;
determining, for each of the plurality of conceptual habitat layouts, a plurality of quantifiable habitat layout evaluation criteria and a plurality of utility functions, each utility function quantifying the evaluation criteria;
calculating the plurality of utility functions for each of the conceptual habitat layouts; and
calculating a acceptability value based on the plurality of utility functions for each of the plurality of conceptual habitat layouts; and
determining a maximum acceptability value of one of the plurality of conceptual habitat layout; and
creating a file configured to provide a user-viewable blueprint of the layout having the maximum acceptability value.

16. The method of claim 15, wherein calculating the plurality of utility functions includes normalizing each of the plurality of evaluation criteria to common units.

17. The method of claim 15, wherein calculating the plurality of utility functions includes applying criteria weighting to each of the plurality of evaluation criteria to account for relative importance of each evaluation criteria.

18. The method of claim 15, further comprising determining a plurality of penalty functions for each of the habitat constraints and calculating the plurality of penalty functions for the conceptual habitat layout, wherein calculating the acceptability value is further based on the penalty functions.

19. The method of claim 15, wherein the plurality of quantifiable habitat layout evaluation criteria includes one or more of: total line run mass, habitable volume, unusable volume, spatial vista, anthropometric interferences between tasks, placement of items, separation for privacy, separation of clean spaces, and separation for noise.

20. The method of claim 15, wherein the one or more habitat constraints include at least one of: a number of object-to-object collisions, a number of object-to-pressure vessel collisions; a number of anthropometric envelope-to-object collisions, a number of object-to-translation path collisions, and a number of object-to-hatch clearance envelope collisions.
